(19) United States
(12) Patent Application Publication
(10) Pub. No.: US 2025/0310917 A1
(43) Pub. Date: Oct. 2, 2025

(54) Enabling Localized Services in Hosting Network

(71) Applicant: Apple Inc., Cupertino, CA (US)

(72) Inventors: Sridhar PRAKASAM, Fremont, CA (US); Anikethan Ramakrishna VIJAYA KUMAR, Mysuru (IN); Behrouz AGHILI, Poway, CA (US); Krisztian KISS, Rancho Santa Fe, CA (US); Nirlesh KOSHTA, Bangalore (IN)

(21) Appl. No.: 18/863,150

(22) PCT Filed: May 3, 2023
(86) PCT No.: PCT/US2023/020784

§ 371 Date: Nov. 5, 2024

(30) Foreign Application Priority Data
May 6, 2022 (IN) 202241026502

(51) Int. Cl. H04W 60/04; H04W 48/18; H04W 76/20; H04W 84/04

(52) U.S. Cl. CPC H04W 60/04; H04W 48/18; H04W 76/20; H04W 84/042

(57) ABSTRACT

A user equipment (UE) is configured to receive an indication that a localized service is available at a non-public network (NPN) and transmit a registration request to the NPN. In some cases, the indication that the localized service is available at the NPN is provided in broadcast information. In other cases, the indication that the localized service is available at the NPN is provided in one or more non-access stratum (NAS) signals.

### BACKGROUND

A user equipment (UE) may connect to a non-public network (NPN). A NPN generally refers to a fifth generation (5G) system deployed for non-public use. An NPN may be deployed as a standalone NPN (SNPN) which does not rely on the network functions of a public land mobile network (PLMN) or a public network integrated NPN (PNI-NPN) which is deployed with the support of a PLMN. There exists a need for enhancements configured to support the deployment of NPNs.

### SUMMARY

Some exemplary embodiments are related to a processor of a user equipment (UE) configured to perform operations. The operations include receiving an indication that a localized service is available at a non-public network (NPN) and transmitting a registration request to the NPN.

Other exemplary embodiments are related to one or more processors of a localized service function (LSF) configured to perform operations. The operations include transmitting information to an access and mobility management function (AMF) indicating one or more localized services available at a user equipment (UE) location and activating or deactivating a first localized service at the UE location.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary fifth generation (5G) System architecture comprising a localized service function (LSF) according to various exemplary embodiments.

FIG. 4 shows exemplary network architecture according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques configured to support the deployment of non-public networks (NPNs).

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

Throughout this description, the term “NPN” generally refers to a 5G system deployed for non-public use. Thus, the NPN may be configured to be utilized by a private entity and may be isolated from public access. An NPN may be further characterized as a standalone-NPN (SNPN) or a public network integrated (PNI-NPN). The term “SNPN” may refer to an NPN that does not rely on the network functions of a public land mobile network (PLMN) and the term “PNI-NPN” may refer to a network deployed with the support of a PLMN. Specific examples of the physical and virtual components that may be included in a NPN will be described in detail below.

In addition, the exemplary embodiments are described with regard to localized service. Throughout this description, the term “localized service” may represent a service which is localized (e.g., provided at a specific/limited area) and/or may be bounded in time. The service may be realized via applications (e.g., live or on-demand audio/video stream, IMS, gaming, virtual reality (VR), augmented reality (AR), etc.) or connectivity (e.g., UE to UE, UE to data network, etc.). The term “hosting network” may be used to refer to a network that provides localized service. A hosting network may be a NPN (e.g., SNPN or PNI-NPN).

The exemplary embodiments are also described with regard to a home network. Throughout this description, the term “home network” may represent a PLMN or NPN owning the current in use subscription/credential of a UE. Those skilled in the art will understand that the term “home network” does not imply a roaming relationship.

As will be described in more detail below, in one aspect, the exemplary enhancements described herein include techniques for enabling NPN as a hosting network for providing access to localized services. In a further aspect, enhancements described herein include techniques for enabling access to localized services via a specific hosting network. Each of the exemplary techniques introduce herein may be used independently from one another, in conjunction with currently implemented NPN mechanisms, in conjunction with future implementations of NPN mechanisms or independently from other NPN mechanisms.

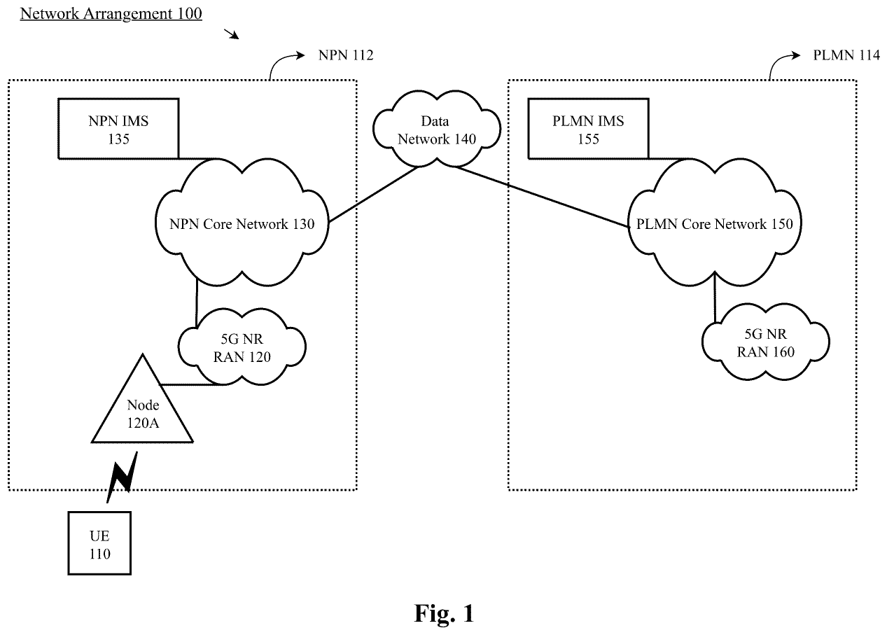

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the networks with which the UE 110 may wirelessly communicate are an NPN 112 and a PLMN 114. The NPN 112 may be deployed by a private entity. In some examples, the UE 110 may access the PLMN 114 via the NPN 112. For instance, if the NPN 112 is an SNPN, the UE 110 may access both the SNPN and the PLMN 114. In other examples, the NPN 112 may be deployed with the support of the PLMN 114 (e.g., PNI-NPN). Similarly, while beyond the scope of the exemplary embodiments, UEs with credentials to access the NPN 112 may be permitted to access the NPN 112 via a public network (e.g., the PLMN 114).

The UE 110 may wirelessly access the NPN 112 via a 5G new radio (NR) radio access network (RAN) (5G NR RAN) 120. For example, the 5G NR PAN 120 may include one or more nodes, cells or base stations (Node-Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. However, it should be understood that the UE 110 may also access the NPN 112 over a wired connection or using any other appropriate type of PAN. Therefore, the UE 110 may include, at least, a 5G NR chipset to communicate with the 5G NR-RAN 120.

In the network arrangement 100, the UE 110 may connect to the 5G NR PAN 120 via the node 120A. Those skilled in the art will understand that any association procedure may be performed for the UE 110 to connect to the 5G NR-RAN 120. For example, the UE 110 may be associated with the private entity that deployed the NPN 112. Thus, the UE 110 may be provisioned with credentials to access the NPN 112. When operating in NPN access mode, the UE 110 may be configured to search for and identify nodes of the NPN 112 (e.g., node 120A). Upon detecting the presence of the 5G NR-RAN 120, the UE 110 may transmit the corresponding credential information to associate with the 5G NR-RAN 120. More specifically, the UE 110 may associate with a specific node (e.g., the node 120A of the 5G NR-RAN 120). Reference to one node and one RAN is merely provided for illustrative purposes. Those skilled in the art will understand that an actual NPN may include any appropriate number of RANs and corresponding nodes.

In addition to the 5G NR RAN 120, the NPN 112 may also include an NPN core network 130 and an NPN IMS 135. The NPN core network 130 may be considered to be the interconnected set of components that manages the operation and traffic of the cellular network. The NPN core network 130 also manages the traffic that flows between the cellular network and the data network 140 (e.g., the Internet, etc.). The NPN IMS 135 may be generally described as an architecture for delivering multimedia services to the UE 110 using the IP protocol. The NPN IMS 135 may communicate with the NPN core network 130 and the data network 140 to provide the multimedia services to the UE 110. In some embodiments, the functionality described for the NPN core network 130 and/or the NPN IMS 135 may include a cloud implementation such as a set of virtual or hardware servers hosting firmware. The exemplary embodiments are not limited to any particular network configuration and may be applicable to any appropriate arrangement of hardware, software and/or firmware.

The UE 110 may access network services from the PLMN 114 while connected to the NPN 112. In some embodiments, this may include the UE 110 connecting to the PLMN 114 via the NPN 112. For example, once registered with the NPN core network 130, the UE 110 may utilize the NPN 112 for non-third generation partnership program (3GPP) access to the PLMN 114 via the data network 140. The UE 110 may then register with the PLMN 114 (using the credential of the PLMN 114) and receive network services from the PLMN 114 via the NPN 112. This functionality may be facilitated by various network functions on both the NPN 112 side and the PLMN 114 side.

The PLMN 114 may represent a cellular network that may be deployed by a cellular provider (e.g., Verizon, AT&T, Sprint, T-Mobile, etc.) over a particular geographical location. The UE 110 be permitted to access the PLMN 114. For example, the UE 110 and/or the user thereof may have a contract and credential information (e.g., stored on a SIM card) to utilize the PLMN 114. In another example, the UE 110 may have a contract with a cellular provider that has an agreement with the cellular provider of the PLMN 114. Thus, in this type of scenario, UEs with a home PLMN that has an agreement with the PLMN 114 may be permitted to utilize the PLMN 114. In a further example, the UE 110 may be permitted to utilize the PLMN 114 for emergency services. Accordingly, there are a variety of different scenarios in which the UE 110 may be permitted to utilize the PLMN 114. The exemplary embodiments may apply to any scenario in which the UE 110 is configured to utilize the PLMN 114.

The UE 110 may directly access the PLMN 114 via the 5G NR PAN 160. For example, the 5G NR PAN 160 may include one or more nodes, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. Upon detecting the presence of the 5G NR-RAN 160, the UE 110 may transmit the corresponding credential information to associate with the 5G NR PAN 160. More specifically, the UE 110 may associate with a specific node (not pictured) of the 5G NR RAN 160. However, Reference to one PAN is merely provided for illustrative purposes. Those skilled in the art will understand that an actual PLMN may include any appropriate number of RANs and corresponding nodes.

In addition to the 5G NR PAN 160, the PLMN 114 may include a PLMN core network 150 and a PLMN IMS 155. The PLMN core network 150 may be considered to be the interconnected set of components that manage the operation and traffic of the cellular network. The PLMN core network 150 also manages the traffic that flows between the cellular network and the data network 140. Those skilled in the art will understand that in an actual network arrangement the PLMN 114 may share a core network with other PLMNs.

The PLMN IMS 155 may be generally described as an architecture for delivering multimedia services to the UE 110 using the IP protocol. The PLMN IMS 155 may communicate with the PLMN core network 150 and the data network 140 to provide the multimedia services to the UE 110. In some embodiments, the functionality described for the PLMN core network 150 and/or the PLMN IMS 155 may include a cloud implementation such as a set of virtual or hardware servers hosting firmware. The exemplary embodiments are not limited to any particular network arrangement configuration and may be applicable to any appropriate arrangement of hardware, software and/or firmware.

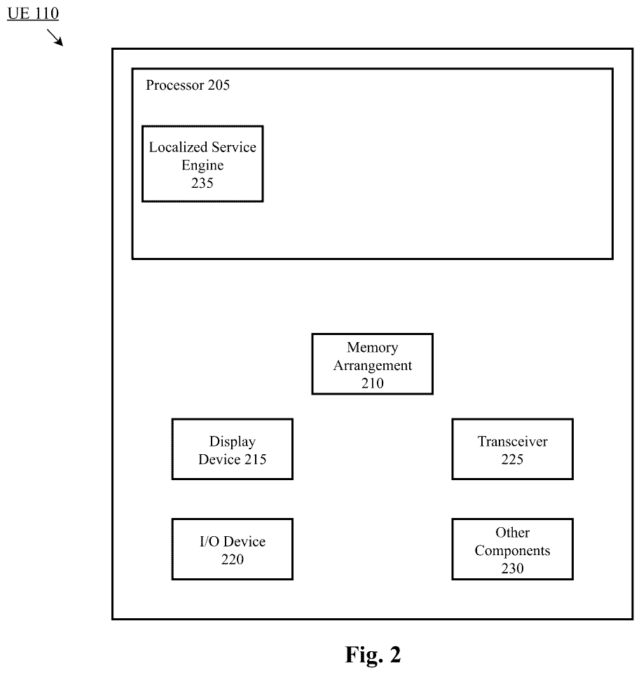

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a localized service engine 235. The localized service engine 235 may perform various operations related to identifying the availability of and accessing localized services.

The above referenced localized service engine 235 being an application (e.g., a program) executed by the processor 205 is merely provided for illustrative purposes. The functionality associated with the localized service engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

According to some aspects, the exemplary embodiments introduce techniques that are configured to enable the UE 110 to become aware of the availability of localized services. In one approach, the indication of the availability of localized services may be provided via broadcast information. In some embodiments, a hosting network may broadcast a signal indicating an availability of localized services. The signal may identify the availability of localized services in general without specifically identifying the type of services that are available at the hosting network. The exemplary embodiments introduce a new information element (IE) to be used by a hosting network to indicate that localized services are available. In other examples, an existing IE may be configured to indicate that localized services are available. Alternatively, the hosting network may broadcast one or more signals indicating the specific type of localized services that may be available to UEs at the hosting network.

In other embodiments, a currently camped network may broadcast a signal indicating an availability of localized services at a hosting network that is within the vicinity of the UE 110 and/or the currently camped network. From the perspective of the UE 110, the currently camped network may be a home network (e.g., PLMN, NPN, etc.) or any other appropriate type of network that may agree to broadcast this type of availability indication on behalf of the hosting network.

In other embodiments, the UE 110 may be preconfigured to autonomously search for localized services. The preconfigured search parameters may include specific SNPN IDs that provide localized services, a geographical location or region at which localized services are available, a time of day at which localized services are available and/or any other type of information that may be used by the UE 110 to identify when, where and/or at which hosting networks localized services may be available to the UE 110. The preconfigured parameters may be set by a manufacturer of the UE 110, provided by a home network or provided by any other appropriate source.

In another approach, an indication of the availability of localized services may be provided via non-access stratum (NAS) signaling. In some embodiments, the UE 110 may perform a registration procedure with a hosting network to obtain a list of available localized services at the hosting network. The UE 110 may enquire or request specific types of localized services that the UE 110 intends to access. Alternatively, the UE 110 may request information regarding all or a subset of available localized services.

The UE 110 may receive a list comprising one or more localized services available at the hosting network. If the received list includes services that are subscribed or configured by a home operator, the UE 110 may activate the services. In addition, the hosting network may also indicate how a localized service is to be accessed. For example, the network may indicate to the UE 110 that the UE 110 should register to a specific network slice and/or packet data unit (PDU) session to access a particular localized service. In some embodiments, the mapping may be provided by the hosting network on a per service basis where every available service is provided a network slice and/or PDU session that may provide the corresponding localized service.

When the UE 110 registers with a network, the UE 110 may receive a list of tracking areas (TAs) (e.g., localized service availability area) where the UE 110 has access to localized services in the PLMN/SNPN. The UE 110 may trigger a search and attempt to discover localized services when the UE 110 enters a TA present in the localized service availability area list. Thus, instead of performing periodic blind searches to discover localized services, the UE 110 may be triggered to perform a search for a localized service when entering a TA where a localized service is likely to be available to the UE 110. In addition, the network may provide a mapping between the TAs of the localized service availability area list and a localized service access method. For example, the mapping may include a specific network slice configured to provide a localized service and the area in which the UE 110 may access the network slice. In another example, the mapping may include a specific network slice and/or data network name (DNN) and the TAs of the localized service availability area list. In another example, the mapping may include an application ID and the TAs of the localized service availability area list.

In another approach, an indication of the availability of localized services may be provided via application layer procedures. After the UE 110 is registered with a network, the UE 110 may utilize application layer discovery procedures that are preconfigured by a home operator to obtain a list of available localized services along with hosting networks that provide these services. For example, the UE 110 may receive a short message service (SMS), a push notification, a page or any other appropriate type of signal comprising information about the availability of localized services. The user may be triggered to attempt to activate localized services based on the received signal (e.g., SMS, etc.).

In another approach, an indication of the availability of localized services may be provided via dedicated radio resource control (RRC) signaling. This may enable the UE 110 to avoid scenarios in which the UE 110 registers with a hosting network only to discover that the hosting network does not provide and/or the UE 110 is not permitted to access a type of localized service the UE 110 intends to utilize. In some embodiments, an access and mobility management function (AMF) of a core network may inform an access node (e.g., gNB, base station, etc.) of a RAN that localized services are to be provided.

When the UE 110 tries to establish an RRC connection, the UE 110 may be informed by the access node of the availability of localized services. In one example, a new establishment cause, reserved for localized services, may be defined and the UE 110 may provide the exemplary establishment cause in the RRC connection request message so that the RAN understand that the UE 110 is trying to establish a connection for the purposes of accessing localized services. The RAN may then inform the UE 110 in the RRC setup message whether or not localized services are provided by the RAN via the access node. In another example, a new indication or flag may be used by the UE 110 to inform the access node (e.g., gNB) that the UE 110 intends to utilize localized services. In this example, the UE 110 may use an existing establishment cause that is configured to include this new indication or flag so that the access node may inform the UE 110 whether or not localized services are available.

A scenario may occur where the UE 110 registers with the network and was informed that localized services are not available. Subsequently, there may be changes to the network configuration and the localized services have now become available. In this type of scenario, the network may use a paging message to bring the UE 110 to RRC connected mode and then perform a UE configuration update (UCU) to inform the UE 110 that localized services have become available. Alternatively, one or more of the exemplary dedicated RRC signaling techniques described above may be triggered by the paging message to inform the UE 110 that localized services are available.

As indicated above, there may be scenarios where a localized service is only available for a certain duration. For example, a live event may be held at a stadium (e.g., sporting event, concert, etc.) and a hosting network may be configured to provide augmented reality (AR) services associated with the event for a particular time duration. In this type of scenario, the network may provide a timer value to the UE 110 along with information for a corresponding localized service. The UE 110 may initiate a timer in response to this information and upon expiry of the timer, the UE 110 may consider that the corresponding localized service is no longer available. During operation, the network may update the value of the timer via NAS signaling. If a new timer value is received, the UE 110 may reset the timer with the new value.

There may also be scenarios where a localized service is only available at a certain location. For instance, the UE 110 may be aware of where certain localized services are available based on the localized service availability area list mentioned above comprising various TAs or based on any other appropriate type of information. Continuing with the example provided above, the AR services associated with the event may only be available to users located within the vicinity of the stadium, within the stadium itself or within a particular area of the stadium. When the UE 110 moves out of an area providing a localized service, the UE 110 shall not attempt to access the localized services associated with the corresponding area. Thus, the UE 110 may not initiate a service request or include uplink data status for a PDU session requesting dedicated radio bearers (DRBs) for the one or more PDU sessions through which the localized service was previously accessed to send/receive data for this localized service when outside of the indicated area. However, the UE 110 and the network may keep the associated network slice and PDU session context active and may attempt to reuse the context if the UE 110 returns to the area where the localized service is allowed to be accessed by the UE 110.

According to some aspects, the exemplary embodiments introduce techniques for the UE 110 to differentiate between localized services and non-localized services (e.g., regular services, etc.). In one example, localized services may be associated with a particular DNN, application identifier (ID), single network slice selection assistance information (S-NSSAI) or any other appropriate type of identifier. The association may be provided to the UE 110 by a home network, preconfigured at the UE 110, hard encoded in various Specifications or may be provided to the UE 110 in any other appropriate manner. The UE 110 may receive configuration information identifying services that may be available at a currently camped network or at another network and then determine that a service is a localized service based on the identifying the associated DNN, application ID, S-NSSAI, etc. In another example, an indication that a service is only available at a certain location and/or time may implicitly indicate that the service is a localized service.

In a further example, using either preconfigured information or information dynamically configured via NAS signaling, the network may provide the UE 110 with “localized service information.” The localized service information may include information as to how the UE 110 may access localized services (e.g., DNN, S-NSSAI, application ID, PDU session ID, etc.). The exemplary embodiments introduce a localized service information IE that may be used to provide this type of information to the UE 110. Then the UE 110 receives the localized service information IE, the UE 110 may consider the received PDU session ID, S-NSSAI and/or application ID as solely offering localized services. The network may also use the localized service information IE to indicate a location and/or time restriction (if any) to access the localized service. In some embodiments, all DNNs, S-NSSAI, and/or application IDs not included in the localized service information may be treated by the UE 110 as non-localized service (e.g., regular service, etc.).

According to some aspects, the exemplary embodiments introduce a new network function for handling localized services. Throughout this description, this new network function may be referred to as a localized services function (LSF). However, reference to LSF is provided for illustrative purposes. Different entities may refer to a similar type of network function by a different name.

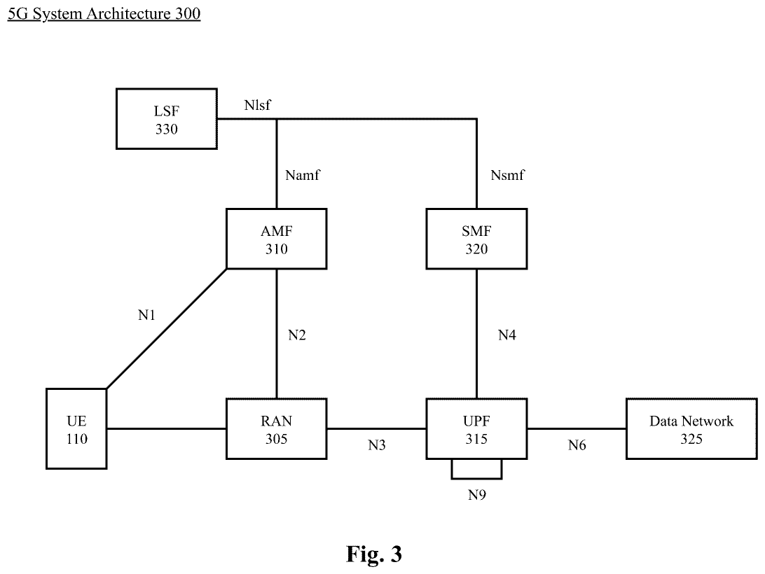

FIG. 3 shows an exemplary 5G System architecture 300 comprising a LSF according to various exemplary embodiments. The various components are shown as being connected via connections labeled Nx (e.g., N1, N2, N3, N4, N6, N9, Namf, Nsmf, etc.). Those skilled in the art will understand that each of these connections (or interfaces) are defined in the 3GPP Specifications. The exemplary architecture 300 is using these connections in the manner in which they are defined in the 3GPP Specifications and may be modified in accordance with the exemplary embodiments described herein. Furthermore, while these interfaces are termed connections throughout this description, it should be understood that these interfaces are not required to be direct wired or wireless connections, e.g., the interfaces may communicate via intervening hardware and/or software components. To provide an example, the UE 110 may exchange signals over the air with an access node of the PAN 305. However, in the architecture 300 the UE 110 is shown as having a connection to the AMF 310 via the N1 interface. This interface is not a direct communication link between the UE 110 and the AMF 310, instead, it is a connection that is facilitated by intervening hardware and software components. Thus, throughout this description the terms “connection” and “interface” may be used interchangeably to describe the Nx interface between the various components.

The architecture 300 includes the UE 110, a PAN 305, an AMF 310, a user plane function (UPF) 315, a session management function (SMF) 320, a data network (DN) 325 and the LSF 330. Those skilled in the art will understand that the 5G system architecture may include a variety of network functions in addition to the components shown in FIG. 3.

Those skilled in the art will understand that the components of the exemplary architecture 300 may reside in various physical and/or virtual locations relative to the network arrangement 100 of FIG. 1. These locations may include, within the access network (e.g., PAN 120), within the core network 130, as separate components outside of the locations described with respect to FIG. 1, etc.

The AMF 310 is generally responsible for connection and mobility management. Those skilled in the art will understand that the AMF 310 is a control plane function and may perform operations related to registration management and connection management. For example, the AMF 310 may perform operations related to registration management between the UE 110 and the core network. The exemplary embodiments are not limited to an AMF that performs the above referenced operations. Those skilled in the art will understand the variety of different types of operations an AMF may perform. Further, reference to a single AMF 310 is merely for illustrative purposes, an actual network arrangement may include any appropriate number of AMFs.

The SMF 320 may perform operations related to session management such as, but not limited to, session establishment, session release, IP address allocation, policy and QoS enforcement, etc. During operation, the UE 110 and the SMF 320 may exchange PDU session establishment requests and PDU session establishment responses or perform PDU session modification procedures. The exemplary embodiments are not limited to an SMF that performs the above referenced operations. Those skilled in the art will understand the variety of different types of operations a SMF may perform. Further, reference to a single SMF 320 is merely for illustrative purposes, an actual network arrangement may include any appropriate number of SMFs.

The UPF 315 performs operations related PDU session management. For example, the UPF 315 may facilitate a connection between the UE 110 and the DN 325. The UPF 315 may be equipped with one or more communication interfaces to communicate with other networks and/or network components (e.g., network functions, PANs, UEs, etc.). The exemplary embodiments are not limited to a UPF that performs the above reference operations. Those skilled in the art will understand the variety of different types of operations an UPF may perform. Further, reference to a single UPF 315 is merely for illustrative purposes, an actual network arrangement may include any appropriate number of UPFs.

The LSF 330 may perform operations related to handling localized services. In some embodiments, the LSF 330 may provide information to the AMF 310 about which localized services are available at the UE 110 location. The availability of the localized services may be provided to the UE 110 using NAS signaling that may be forwarded to the application layer (e.g., NAS transport messages or using the data plane after activating a PDU session).

The activation or deactivation or any new localized service in the location may be handled by the LSF 330 and/or updated in the LSF 330. In some embodiments, a third party application server may contact the LSF 330 to configure a number of users allowed to use the localized service (e.g., dynamic load balancing) via a network exposure function (NEF) (not pictured in the architecture 300) or as part of a PCO/ePCO IE in a PDU session establishment accept message.

Various localized services may be provided by the hosting network and a list of localized services at various location may be maintained by the LSF 330. The UE 110 may be provided an indication of the available localized services provided by a hosting network via NAS signaling or over data plane. This may help users make an informed selection or activation of localized services on the local hosting network.

An addition or deletion of localized services may be done by an authorized PLMN providing the underlying UE services. For example, if a third party application service provider wants to provide services in a location spanning multiple tracking areas and optionally, multiple AMFs, then the LSF 330 may help in deciding which localized services may be applicable at the location.

In some embodiments, the LSF 330 may be accessible within the NPN core network. The LSF 330 may track one or more location based services for different coverage locations in a PLMN or NPN. For example, the AMF 310 may query the LSF 330 to determine a presence of localized services for the UE 110 location. The LSF 330 may then provide a list of localized services to the AMF 310. In some embodiments, the LSF 330 may provide event based reporting to network functions (e.g., AMF 310, etc.) to dynamically update the network function about any services that are currently available or not based on load conditions. For example, if an S-NSSAI is serving a maximum number of UEs, the LSF 330 may inform the AMF 310 that the corresponding localized service is not currently available.

In some embodiments, once an AMF determines that location services may be provided in the UE 110 location, a home routed roaming architecture may be utilized to enable the core network to provide a first type of service (e.g., voice services, etc.) and simultaneously offload localized service traffic to the local network (e.g., camped NPN).

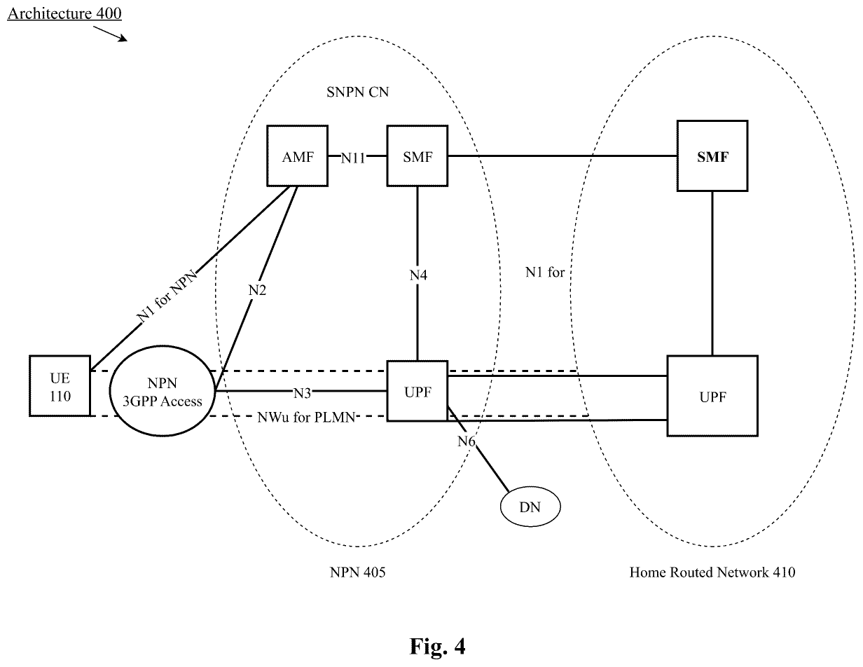

Instead of utilizing an LSF or similar type of network function to handle localized services for NPN, an overlay and underlay network architecture for home routed and localized services may be utilized. FIG. 4 shows an example of this exemplary architecture 400. In this example, the UE 110 is camped on the NPN 405 which is connected to the home routed network 410. In some embodiments, only essential services such as voice services may be provided as a home routed service and all other traffic may be served by the local data network.

### Examples

In a first example, a method performed by a user equipment (UE), comprising receiving an indication that a localized service is available at a non-public network (NPN) and transmitting a registration request to the NPN.

In a second example, the method of the first example, wherein the indication that the localized service is available at the NPN is provided in broadcast information.

In a third example, the method of the second example, wherein the broadcast information is provided by the NPN.

In a fourth example, the method of the second example, wherein the broadcast information is provided by a second different NPN or a public land mobile network (PLMN).

In a fifth example, the method of the first example, wherein the indication is an information element (IE) configured to indicate that the localized service is available.

In a sixth example, the method of the first example, wherein the indication identifies a specific type of localized service available at the NPN.

In a seventh example, the method of the first example, wherein the indication that the localized service is available at the NPN is provided in one or more non-access stratum (NAS) signals.

In an eighth example, the method of the first example, wherein the indication that the localized service is available at the NPN is provided in response to the registration request and comprises a list of available localized services at the NPN.

In a ninth example, the method of the eighth example, further comprising receiving, after transmitting the registration request, information for how to access the localized service, the information comprising a single network slice selection assistance information (S-NSSAI), a packet data unit (PDU) session ID corresponding to the localized service or an application identifier through which to access localized services.

In a tenth example, the method of the eighth example, further comprising receiving a list of tracking areas (TAs) where access to one or more localized services are available, wherein transmitting the registration request to the NPN is triggered based on the UE entering one of the TAs where access to the one or more localized services are available.

In an eleventh example, the method of the first example, wherein the indication that the localized service is available at the NPN is provided during an application layer procedure performed after the UE is registered with the NPN.

In a twelfth example, the method of the first example, wherein the indication that the localized service is available at the NPN comprises one or more time periods when access to the localized service is valid.

In a thirteenth example, the method of the first example, wherein the indication that the localized service is available at the NPN comprises a limited geographical area where the localized service is valid.

In a fourteenth example, the method of the thirteenth example, further comprising receiving a set of tracking areas (TAs) comprising one or more TAs where the localized service is valid, wherein the UE does not attempt to access the localized service outside of the one or more TAs.

In a fifteenth example, the method of the first example, wherein the localized service is only valid in a limited geographical area, the method further comprising identifying that the UE has exited the limited geographical area, wherein the UE does not attempt to access the localized service outside of the limited geographical area and wherein the UE keeps a context active for subsequent use within the limited geographical area.

In a sixteenth example, the method of the first example, wherein the indication that the localized service is available at the NPN is provided in dedicated radio resource control (RRC) signaling.

In a seventeenth example, the method of the sixteenth example, further comprising transmitting an RRC connection request message comprising an establishment cause configured to indicate that the UE intends to access one or more localized services.

In an eighteenth example, the method of the first example, wherein the UE identifies that the localized service is available based on an associated data network name (DNN), application ID or a single network slice selection assistance information (S-NSSAI).

In a nineteenth example, the method of the eighteenth example, further comprising receiving a localized service information information element (IE) comprising one or more of data network names (DNNs), one or more application IDs and one or more single network slice selection assistance information (S-NSSAI) that may be used to access the localized service.

In a twentieth example, the method of the nineteenth example, wherein the localized service information IE further comprises an indication of location or time restrictions related to the localized service.

In a twenty first example, one or more processors configured to perform any of the methods of the first through twentieth examples.

In a twenty second example, a user equipment (UE) comprising a transceiver configured to communicate with one or more networks and one or more processors communicatively coupled to the transceiver and configured to perform any of the methods of the first through twentieth examples.

In a twenty third example, a method comprising transmitting information to an access and mobility management function (AMF) indicating one or more localized services available at a user equipment (UE) location and activating or deactivating a first localized service at the UE location.

In a twenty fourth example, the method of the twenty third example, further comprising receiving a signal from an application service to configure a number of users allowed to utilize the first localized service.

In a twenty fifth example, the method of the twenty third example, further comprising maintaining a list of localized services deployed at one or more locations.

In a twenty sixth example, the method of the twenty third example, wherein transmitting the information to the AMF is performed in response to a query received from the AMF.

In a twenty seventh example, the method of the twenty third example, wherein the LSF is configured to perform event based reporting to the AMF to dynamically update the AMF about available localized services.

In a twenty eighth example, one or more processors configured to perform any of the methods of the twenty third through twenty seventh examples.

In a twenty ninth example, a localized service function (LSF) of a cellular core network configured to perform any of the methods of the twenty third through twenty seventh examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations, comprising:
receiving an indication that a localized service is available at a non-public network (NPN); and
transmitting a registration request to the NPN.

2. The processor of claim 1, wherein the indication that the localized service is available at the NPN is provided in broadcast information.

3. The processor of claim 2, wherein the broadcast information is provided by the NPN.

4. The processor of claim 2, wherein the broadcast information is provided by a second different NPN or a public land mobile network (PLMN).

5. The processor of claim 1, wherein the indication is an information element (IE) configured to indicate that the localized service is available.

6. The processor of claim 1, wherein the indication identifies a specific type of localized service available at the NPN.

7. The processor of claim 1, wherein the indication that the localized service is available at the NPN is provided in one or more non-access stratum (NAS) signals.

8. The processor of claim 1, wherein the indication that the localized service is available at the NPN is provided in response to the registration request and comprises a list of available localized services at the NPN.

9. The processor of claim 8, the operations further comprising:
receiving, after transmitting the registration request, information for how to access the localized service, the information comprising a single network slice selection assistance information (S-NSSAI), a packet data unit (PDU) session ID corresponding to the localized service or an application identifier through which to access localized services.

10. The processor of claim 8, the operations further comprising:
receiving a list of tracking areas (TAs) where access to one or more localized services are available, wherein transmitting the registration request to the NPN is triggered based on the UE entering one of the TAs where access to the one or more localized services are available.

11. The processor of claim 1, wherein the indication that the localized service is available at the NPN is provided during an application layer procedure performed after the UE is registered with the NPN.

12. The processor of claim 1, wherein the indication that the localized service is available at the NPN comprises one or more time periods when access to the localized service is valid.

13. The processor of claim 1, wherein the indication that the localized service is available at the NPN comprises a limited geographical area where the localized service is valid.

14. The processor of claim 13, the operations further comprising:
receiving a set of tracking areas (TAs) comprising one or more TAs where the localized service is valid, wherein the UE does not attempt to access the localized service outside of the one or more TAs.

15. The processor of claim 1, wherein the localized service is only valid in a limited geographical area, the operations further comprising:
identifying that the UE has exited the limited geographical area, wherein the UE does not attempt to access the localized service outside of the limited geographical area and wherein the UE keeps a context active for subsequent use within the limited geographical area.

16. The processor of claim 1, wherein the indication that the localized service is available at the NPN is provided in dedicated radio resource control (RRC) signaling.

17. The processor of claim 16, the operations further comprising:
transmitting an RRC connection request message comprising an establishment cause configured to indicate that the UE intends to access one or more localized services.

18. The processor of claim 1, wherein the UE identifies that the localized service is available based on an associated data network name (DNN), application ID or a single network slice selection assistance information (S-NSSAI).

19. The processor of claim 18 the operations further comprising:
receiving a localized service information information element (IE) comprising one or more of data network names (DNNs), one or more application IDs and one or more single network slice selection assistance information (S-NSSAI) that may be used to access the localized service.

20. The processor of claim 19, wherein the localized service information IE further comprises an indication of location or time restrictions related to the localized service.
